(19) United States
(12) Patent Application Publication
(10) Pub. No.: US 2024/0301712 A1
(43) Pub. Date: Sep. 12, 2024

(54) Anti-ballistic shelter for children or students for use at a school

(71) Applicant: Thomas Carey, Clearwater, FL (US)

(72) Inventor: Thomas Carey, Clearwater, FL (US)

(21) Appl. No.: 18/592,803

(22) Filed: Mar. 1, 2024

Related U.S. Application Data
(60) Provisional application No. 63/488,777, filed on Mar. 7, 2023.

(51) Int. Cl. E04H 9/10; A47B 41/00; E04H 9/06; E05B 65/00; F41H 5/04; F41H 5/24; G08B 21/02

(52) U.S. Cl. CPC E04H 9/10; A47B 41/00; E04H 9/06; E05B 65/0075; F41H 5/0471; F41H 5/24; G08B 21/02

(57) ABSTRACT

The anti-ballistic shelter for children or students for use at a school or similar educational institution fulfills dual purposes. Most of the time, the shelter acts as a table for students to perform schoolwork and other educational endeavors. In active shooter scenarios, the device becomes a safe room for swift entry. The anti-ballistic shelter takes the form of a table comprising a plurality of layered slats or sheets of anti-ballistic materials that surround a core of anti-ballistic concrete.

### RELATED APPLICATIONS

This application claims priority to provisional application No. 63/488,777, filed Mar. 7, 2023, titled Anti-ballistic shelter for children or students for use at a school.

### FIELD

This invention relates to the field of protective furniture and more particularly to a device that serves the dual purpose of classroom furniture and protective shelter.

### BACKGROUND

Protecting children in a school environment is an unfortunate necessity. The solutions that have been proposed to date to protect students and teachers against a deranged individual with a rifle at a school have been limited to perimeter protection. For example, detecting firearms at the point of entry, restricting entry via a gate or locked doors, or the presence of on-campus security.

Firearm detection includes commonplace metal detectors, cameras, security officers, and similar devices around the points of entry to a school. Such devices fail when a shooter breaches the property gate perimeter, breaches the exterior building door—that is supposedly locked—bypasses the overwhelmed lone security officer, and makes their way into the halls and classrooms. This leaves the students and teachers at the mercy of the active shooter with no meaningful protection.

What is needed is a means for students and teachers to shelter in-place, while recognizing that space within the classroom is precious real estate and cannot be occupied by a single-use device.

### SUMMARY

The anti-ballistic shelter for children or students for use at a school fulfills dual purposes. Most of the time, the shelter acts as a table for students to perform schoolwork and other educational endeavors. In active shooter scenarios, the device becomes a safe room for swift entry.

The anti-ballistic shelter takes the form of a table comprising a plurality of layered slats or sheets of anti-ballistic materials that surround a core of anti-ballistic concrete.

Tables have found to be in widespread use at schools or other similar educational facilities because of their use by students to read, draw, study, and write and therefore are suitable, convenient, and easily accessible to protect students form active shooters.

The top of the shelter includes an anti-ballistic tabletop formed from steel or similar anti-ballistic material.

One or more sides include a door, creating a space for rapid entry. The door automatically locks when closed, only able to be unlocked from within.

The shelter is fabricated to be resistant to penetration by high-speed ballistic objects, such as bullets, up to and including thirty-caliber, while at the same time providing for a safe and comfortable environment.

Current anti-ballistic shelters in schools and similar educational facilities—such as armored closets—suffer from drawbacks in both weight and cost. Generally formed using metal and heavy and expensive anti-ballistic materials results in a structure that is difficult to place and cost-prohibitive to purchase.

Moreover, such anti-ballistic enclosures have no use except to protect the students during an active shooter scenario.

In contrast, the table safe room anti-ballistic enclosure described herein takes its place as part of the classroom furniture. This creates budgetary benefits by serving multiple purposes, and practical benefits in that the device is in immediate proximity to the students. This reduces transition time by preventing the requirement to move to a remote location. Instead, the students can rapidly transition. Once inside, the locking of the door automatically triggers an electronically-configured control system to transition from the open state to the protective state. In the protective state the shelter activates an environmental control system and means for communication. Communication means includes both audio and video, likely using a commercially available tablet computer with screen that is wirelessly connected to both administrators' computers and central communication headquarters.

In addition to and included within the anti-ballistic table safe room shelter is an environmental control system to ensure that when enclosed within the shelter, the occupants are not deprived of breathable ambient air. The interior air is maintained at an oxygen level of 20% or greater for at least four hours. To avoid over-pressuring, a means of safely releasing excess pressure is provided. For example, this can take the form of an intentional gap in the door seals where air can leak out. This is preferable to something such as a vent, which may create a vulnerability.

The sidewalls of the device rely on the layering of material including ballistic cloth as a lining, in combination with ballistic concrete, to create a structure that is impervious to bullets. The walls/panels are modular, able to be combined to form differing sizes and shapes of structures.

Ballistic cloth is a type of material that is designed to absorb and dissipate energy from a bullet. It is typically made of a woven combination of Kevlar, a strong synthetic fiber, and other materials such as aramid or polyethylene. When a bullet strikes the fabric, the bullet is deformed and absorbed by the fibers, which spread the force of the impact over a wider area and significantly reduce the risk of injury.

Concrete, on the other hand, is a much harder material than ballistic cloth and is able to withstand much more force from a bullet. When a bullet strikes concrete, it is slowed down, fragmented, and the energy is dissipated over a much larger area. This makes it an ideal material for creating barriers that can absorb and dissipate the energy of a bullet.

When these two materials are combined, they create a barrier that is able to absorb and dissipate the energy of a bullet more effectively than either material could on its own. The ballistic cloth helps to absorb the initial shock of the bullet and spread the force of the impact over a larger area, while the concrete helps to slow down and ultimately stop the bullet.

Turning to ballistic concrete specifically, ballistic concrete is an innovative technology used to construct buildings, walls, and other structures that are highly resistant to bullets and other projectiles. It is a durable, lightweight material composed of a combination of concrete and ballistic fibers. Ballistic concrete is typically used in military, law enforcement, and security applications, as well as in building construction in areas where there is a risk of gunfire or other projectiles.

The strength and durability of ballistic concrete is provided by the addition of additional layers of ballistic fibers, which are woven into the concrete mix in such a way as to provide a matrix that can withstand the impact of bullets and other projectiles. The ballistic fibers are generally composed of aramid fibers, such as Kevlar, or other high-strength synthetic fibers. The fibers are woven into the concrete in such a way as to create a matrix that resists the penetration of bullets and other projectiles.

The concrete aggregate used in ballistic concrete is typically finer than that of traditional concrete. This finer aggregate is necessary to ensure that the concrete is able to withstand the impact of the ballistic projectiles. In addition, the aggregate must be able to maintain its structural integrity when subjected to high pressures and temperatures.

The binder used in ballistic concrete is typically Portland cement. This type of cement is known for its strength and durability, making it an ideal choice for this type of application.

Acting as formwork for the ballistic concrete, the sidewalls of the device are preferably formed from fiberglass sections in fixed lengths. For example, six feet in length. The sections can be carried upstairs into the classroom, where they are assembled and concrete is poured within, filling the shells. By using different quantities of sidewalls, and arranging them in different orders, different sized structures can be prepared. In the preferred embodiment, three, six-foot sections are used for each side, creating a structure that is eighteen feet in length.

In addition to the student shelter, a separate anti-ballistic enclosure or shield for the teacher is disclosed. This shelter takes the form of a triangle in the corner of each room. This provides larger accommodation for the adult instructor.

Within the shelter, tablet computers, wirelessly connected, provide both visual and auditory communication with the student occupants of the anti-ballistic table safe room, with other teachers, and with law enforcement. The tablet computers preferably include displays, cameras, microphones, and speakers. The tablet computer for the students communicates with the teacher's tablet computer via a wireless connection, either via a wireless connection open to the entire school or a wireless connection specifically for communication between the student and teacher devices.

Additionally, the teacher communication device may include a distress button to silently alert authorities.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates an isometric view of the anti-ballistic shelter for children or students for use at a school.

FIG. 2 illustrates a top view of the anti-ballistic shelter for children or students for use at a school.

FIG. 3 illustrates a front view of the anti-ballistic shelter for children or students for use at a school.

FIG. 4 illustrates an interior view of the anti-ballistic shelter for children or students for use at a school.

FIG. 5 illustrates a view of a typical section of the anti-ballistic shelter for children or students for use at a school.

FIG. 6 illustrates a schematic view of typical attachment details of the anti-ballistic shelter for children or students for use at a school.

FIG. 7 illustrates a schematic view of an anchoring detail of the anti-ballistic shelter for children or students for use at a school.

FIG. 8 illustrates a cross-sectional view of wall construction of the anti-ballistic shelter for children or students for use at a school.

FIG. 9 illustrates a front view of the teacher shelter of the anti-ballistic shelter for children or students for use at a school.

FIG. 10 illustrates a top view of the teacher shelter of the anti-ballistic shelter for children or students for use at a school.

FIG. 11 illustrates a view of the interior communication equipment of the student shelter of the anti-ballistic shelter for children or students for use at a school.

FIG. 12 illustrates a view of the interior communication equipment of the teacher shelter of the anti-ballistic shelter for children or students for use at a school.

FIG. 13 illustrates a schematic view of the communication and network infrastructure of the anti-ballistic shelter for children or students for use at a school.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

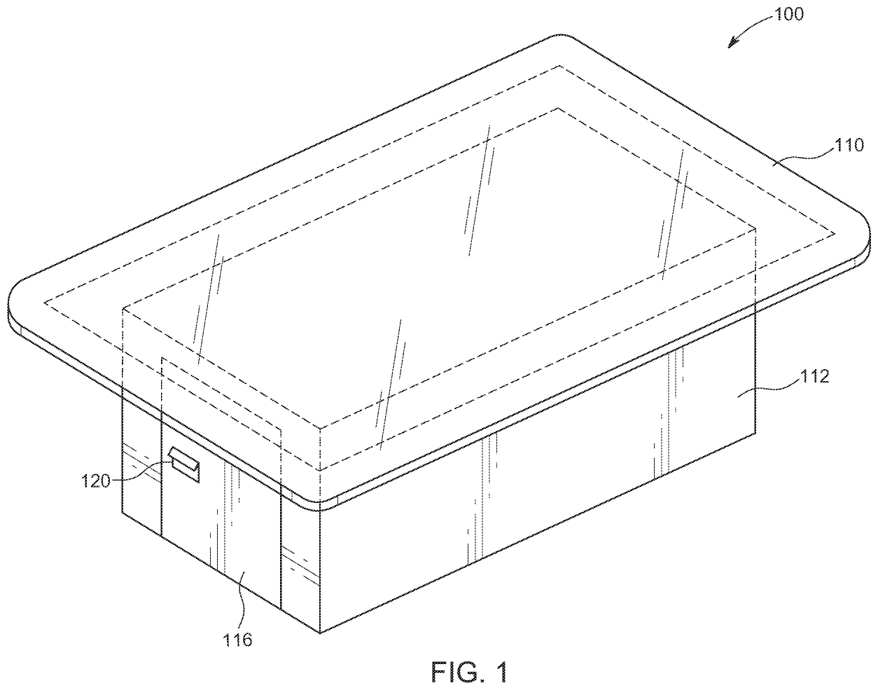

Referring to FIG. 1, an isometric view of the anti-ballistic shelter for children or students for use at a school is shown.

The table with integrated is shown with tabletop 110 on top of sidewalls 112.

The door 116 is shown with external handle 120.

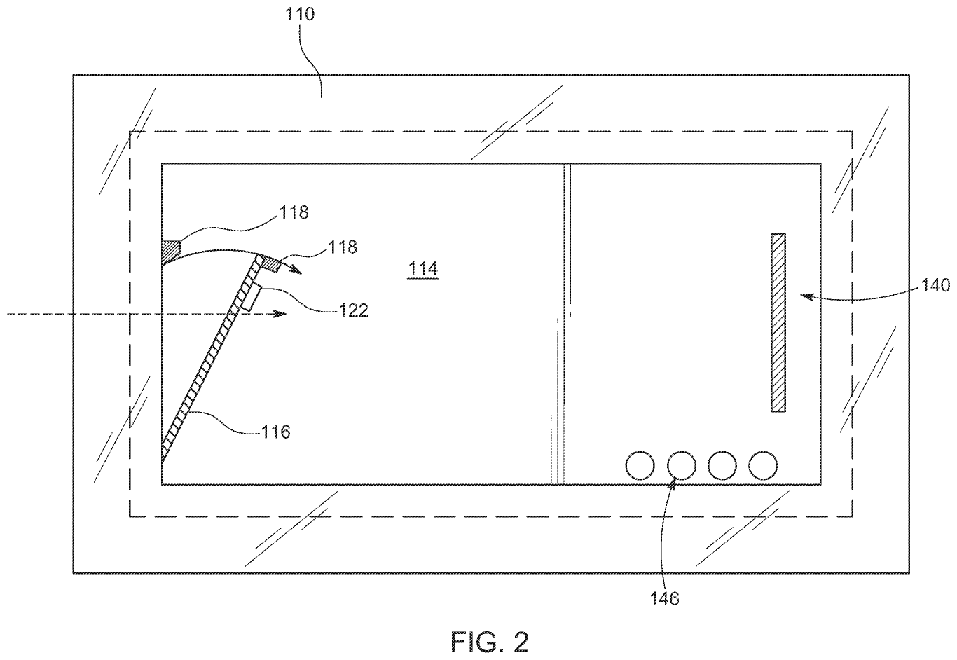

Referring to FIG. 2, a top view of the anti-ballistic shelter for children or students for use at a school is shown.

The door 116 is latched by the automatic locking mechanism 118. An internal handle 122 allows the students to actuate the door 116.

Within the table with the internal space 114 of the integrated shelter 100, the student tablet 140 with integrated camera, microphone, and speakers allows the students to communicate with their teacher.

An oxygen supply 146 ensures that the students have ample oxygen for an extended sheltering situation.

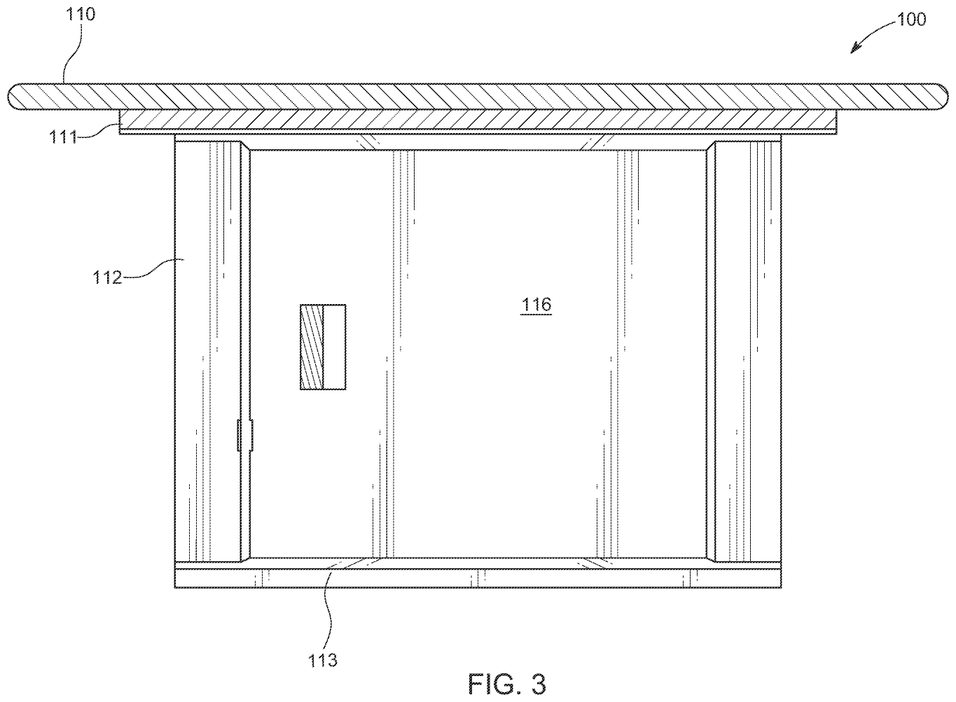

Referring to FIG. 3, a front view of the anti-ballistic shelter for children or students for use at a school is shown.

The tabletop 110 is placed on a secondary top 111 that is likely formed from steel.

The sidewalls 112 connect to the bottom 113, which in turn connects to the floor. The door 116 provides access.

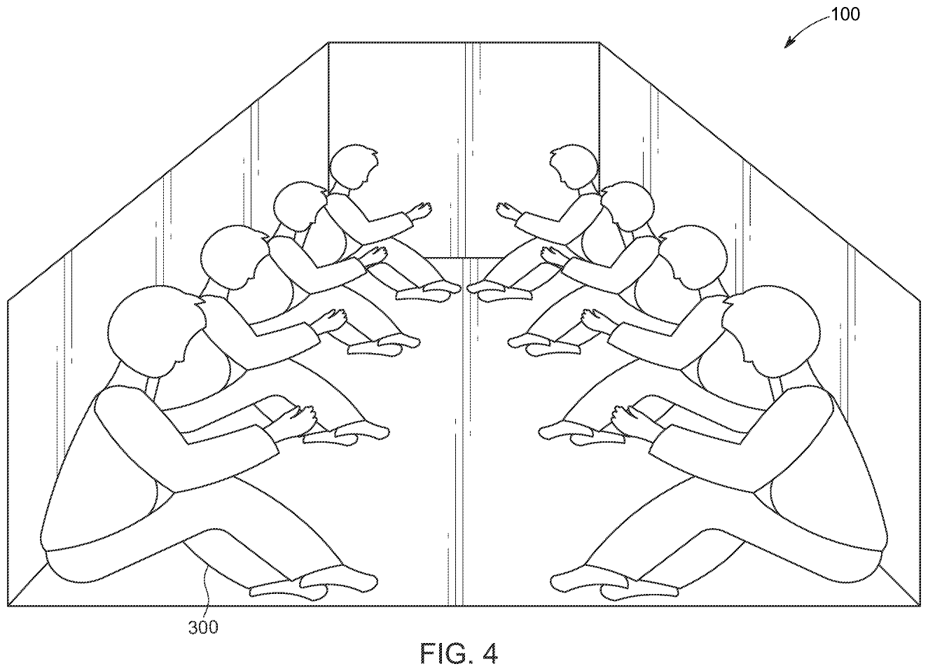

Referring to FIG. 4, an interior view of the anti-ballistic shelter for children or students for use at a school is shown.

The children 300 are shown in the shelter, sitting against the outside walls.

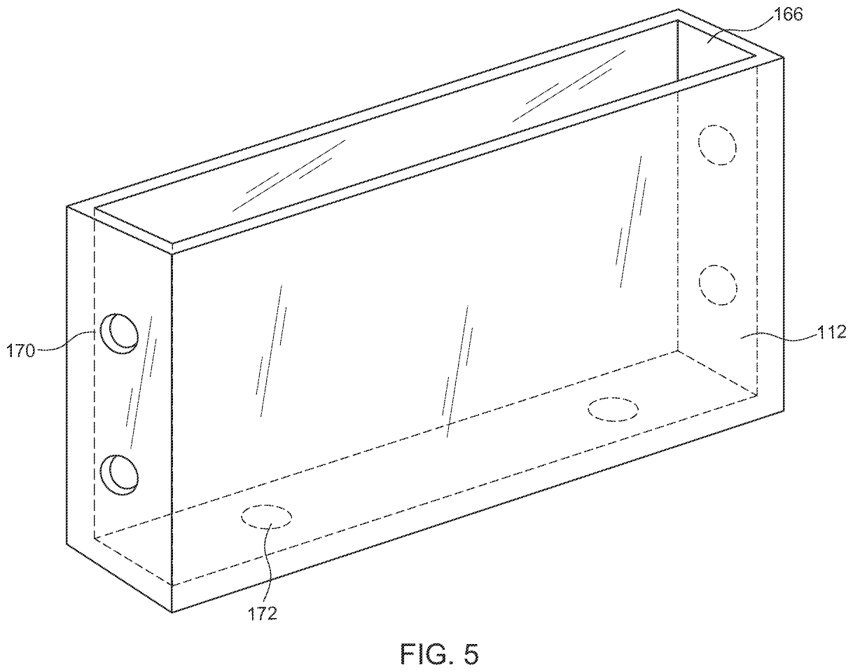

Referring to FIG. 5, a view of a typical section of the anti-ballistic shelter for children or students for use at a school is shown.

The sidewalls 112 include an internal void 166 into which concrete is poured after installation. Wall holes 170 allow sidewalls 112 to be affixed to each other. Base holes 172 allow sidewalls 112 to be affixed to the floor by bolts or other fasteners.

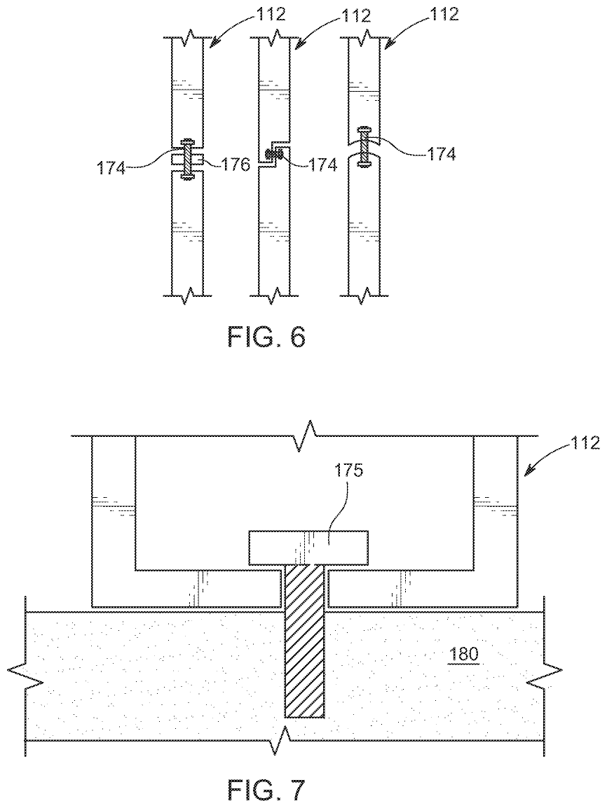

Referring to FIG. 6, a schematic view of typical attachment details of the anti-ballistic shelter for children or students for use at a school is shown.

If the sidewalls 112 connect via butt joints there is a risk that the ballistic resistance will be compromised at the joint because only fiberglass will be present to resist a bullet.

Such a weakness can be overcome by using, for example, a steel plate 176 sandwiched at the joint as shown in the leftmost embodiment, or using various types of offset joints as shown in the middle embodiment and the right embodiment. Such alternative embodiments may require rotation of the connecting fastener 174.

Referring to FIG. 7, a schematic view of an anchoring detail of the anti-ballistic shelter for children or students for use at a school is shown.

A floor anchor 175 holds each side wall 112 to the concrete floor 180. This prevents motion of the structure. The floor anchor 175 is a bolt or similar fastener.

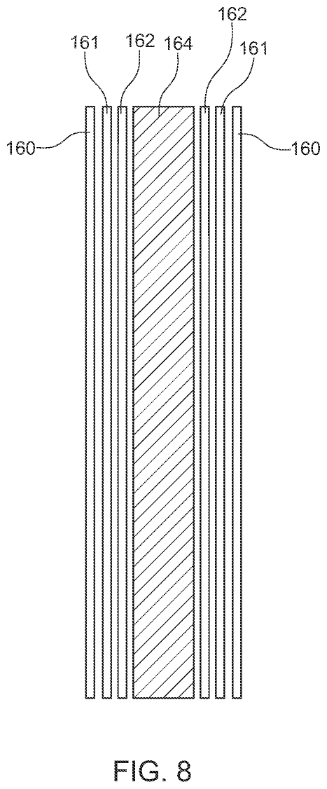

Referring to FIG. 8, a cross-sectional view of wall construction of the anti-ballistic shelter for children or students for use at a school is shown.

A shell formed from fiberglass 160 is layered with a resilient material 161, ballistic cloth 162, and a core of ballistic concrete 164.

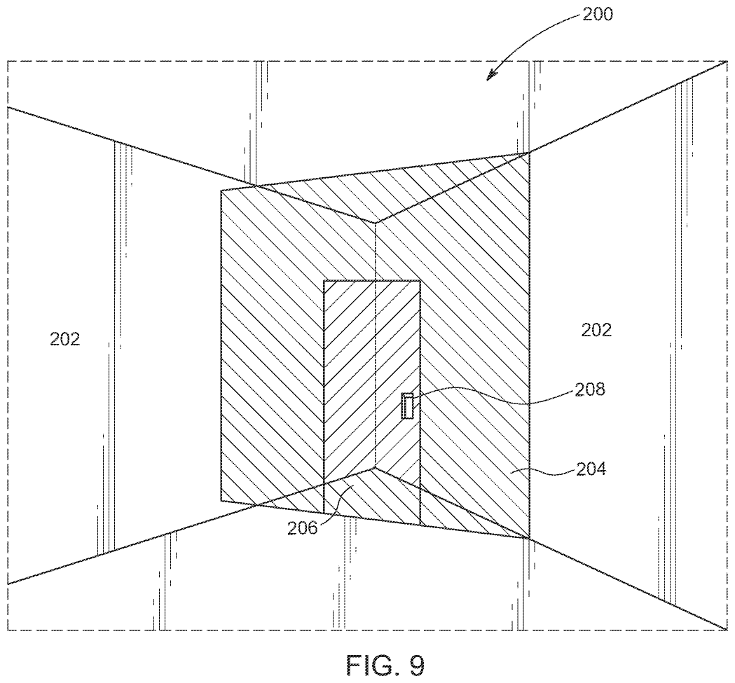

Referring to FIG. 9, a front view of the teacher shelter of the anti-ballistic shelter for children or students for use at a school is shown.

The teacher shelter 200 is formed from a shelter face 204 placed against the classroom walls 202. Access is via a shelter door 206 with shelter handle 208.

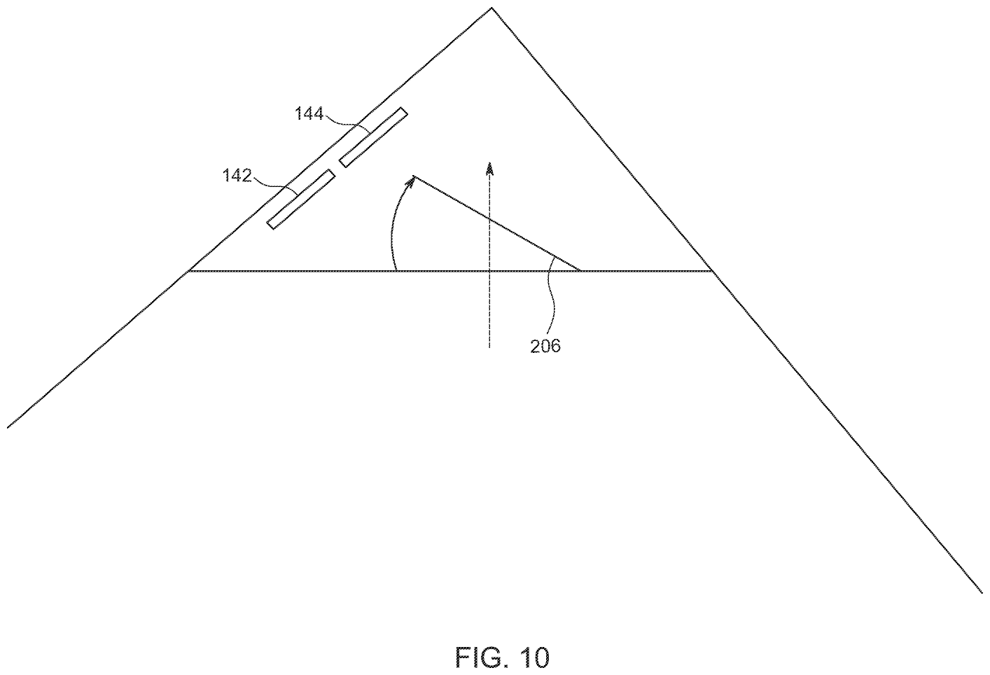

Referring to FIG. 10, a top view of the teacher shelter of the anti-ballistic shelter for children or students for use at a school is shown.

Within the teacher shelter 200, is the teacher's first tablet 142 and the teacher's second tablet 144. This allows the teacher to communicate both with the students that are in the primary shelter, as well as teachers in adjacent rooms and administration. Access is via a shelter door 206.

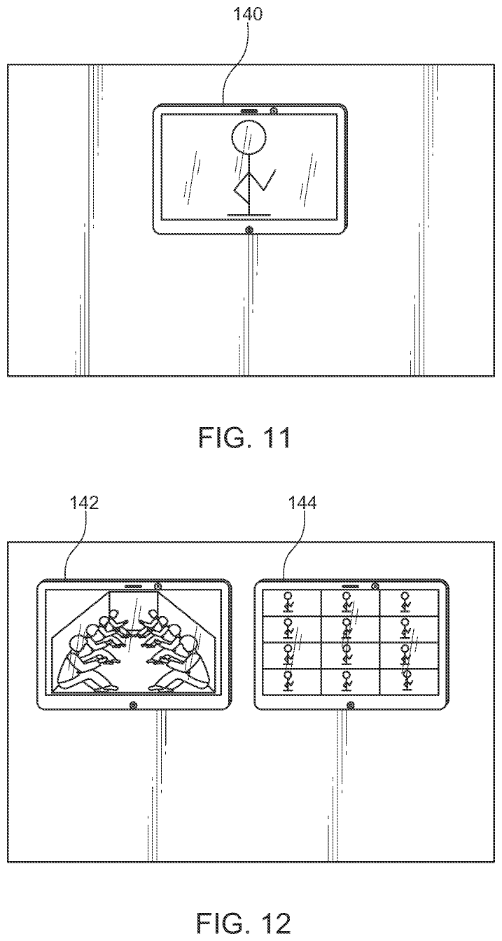

Referring to FIG. 11, a view of the interior communication equipment of the student shelter of the anti-ballistic shelter for children or students for use at a school is shown.

Within the table with integrated shelter 100, an automatically activated student tablet 140 provides communication with the teacher shelter 200.

Referring to FIG. 12, a view of the interior communication equipment of the teacher shelter of the anti-ballistic shelter for children or students for use at a school is shown.

The teacher's first tablet 142 provides communication with the student tablet 140. The teacher's second tablet 144 provides communication with those outside of the classroom, including other teachers, administration, as well as emergency response personnel.

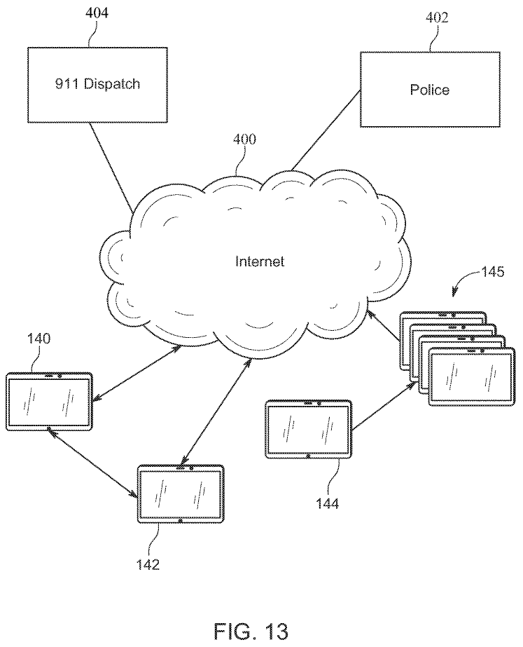

Referring to FIG. 13, a schematic view of the communication and network infrastructure of the anti-ballistic shelter for children or students for use at a school is shown.

The student tablet 140, teacher's first tablet 142, and teacher's second tablet 144 wirelessly communicate with each other. The teacher's second tablet 144 communicates with other in-network tablets 145 that are installed in other teacher shelters, or in administrative facilities.

Using a connection via the Internet 400, teachers and staff can communicate with Police 402 and 911 dispatch 404.

Equivalent elements can be substituted for the ones set forth above such that they perform in substantially the same manner in substantially the same way for achieving substantially the same result.

What is claimed is:

1. A system for sheltering students and teachers in a classroom during an active shooter event, comprising:
a student shelter;
the student shelter formed from two or more modular side walls;
each modular side wall including a fiberglass shell lined with ballistic cloth, an interior of each modular side wall filled with ballistic concrete after placement in a classroom;
the student shelter including a tabletop, allowing the student shelter to function as a table during non-emergency periods;
a teacher shelter;
the teacher shelter formed from a ballistic shield placed in a corner of a classroom against existing classroom walls;
a student communication device and a teacher communication device;
the student communication device including a video screen with camera, microphone, and speaker, connected wirelessly to the teacher communication device;
whereby students and a teacher can shelter in place within a classroom during an active shooter event.

2. The system of claim 1, wherein the two or more modular side walls of the student shelter are connected together by offset joints.

3. The system of claim 1, wherein the two or more modular side walls of the student shelter are connected together at a butt joint, the butt joint including a steel plate sandwiched by two or more modular side walls.

4. The system of claim 1, wherein the tabletop of the student shelter is formed of bullet-resistant material.

5. The system of claim 4, wherein the bullet-resistant material is steel.

6. The system of claim 1, wherein the ballistic shield of the teacher shelter is formed from ballistic steel.

7. The system of claim 1, wherein the teacher communication device includes a distress button to silently alert authorities.

8. The system of claim 1, wherein the student communication device and teacher communication device are connected via a secure wireless network isolated from a school's main data network.

9. The system of claim 1, further comprising:
a door;
the door latched by an automatic locking mechanism that triggers when the door is closed;
an internal handle;
the internal handle allowing students to unlatch the door from within the student shelter.

10. The system of claim 1, wherein each modular side wall of the two or more modular side walls further comprises:
base holes, allowing each modular side wall to be affixed to a floor by a fastener.

11. A modular classroom shelter system for protecting students and teachers during an active shooter event, comprising:
a student shelter having a plurality of connectable ballistic modular panels, each connectable ballistic modular panel comprising a fiberglass shell lined with ballistic resistant material and filled with ballistic concrete, the plurality of connectable ballistic modular panels configured to form a shelter space large enough to contain multiple students, the student shelter including a bullet-resistant tabletop that enables the student shelter to function as a desk during normal use;
a teacher shelter comprising a portable ballistic resistant shield sized to provide cover for a teacher, the teacher shelter configured to be installed in a classroom corner;
a student communication device including a display screen, camera, microphone and speaker for audiovisual communication;
a teacher communication device including a display screen, camera, microphone and speaker for audiovisual communication, the teacher communication device configured to wirelessly communicate with the student communication device;
whereby the modular classroom shelter system allows students and a teacher to quickly take shelter and communicate within a classroom during an active shooter event.

12. The modular classroom shelter system of claim 11, wherein two or more of the plurality of connectable ballistic modular panels of the student shelter are connected together by offset joints.

13. The modular classroom shelter system of claim 11, wherein two or more of the plurality of connectable ballistic modular panels of the student shelter are connected together at a butt joint, the butt joint including a steel plate sandwiched by two or more modular side walls.

14. The modular classroom shelter system of claim 11, wherein the bullet-resistant tabletop is steel.

15. The modular classroom shelter system of claim 11, wherein a ballistic shield of the teacher shelter is formed from ballistic steel.

16. The modular classroom shelter system of claim 11, wherein the teacher communication device includes a distress button to silently alert authorities.

17. The modular classroom shelter system of claim 11, wherein the student communication device and teacher communication device are connected via a secure wireless network isolated from a school's main data network.

18. The modular classroom shelter system of claim 11, further comprising:
a door;
the door latched by an automatic locking mechanism that triggers when the door is closed;
an internal handle;
the internal handle allowing students to unlatch the door from within the student shelter.

19. The modular classroom shelter system of claim 11, wherein each connectable ballistic modular panel of the plurality of connectable ballistic modular panels further comprises:
base holes, allowing each modular side wall to be affixed to a floor by a fastener.

20. A system for sheltering students and teachers in a classroom during an active shooter event, comprising:
a student shelter;
the student shelter formed from two or more modular side walls;
each modular side wall including a fiberglass shell lined with ballistic cloth, an interior of each modular side wall filled with ballistic concrete after placement in a classroom;
the two or more modular side walls of the student shelter are connected together by offset joints;
the student shelter including a tabletop, allowing the student shelter to function as a table during non-emergency periods;
the tabletop of the student shelter is formed of bullet-resistant material;
a teacher shelter;
the teacher shelter formed from a ballistic shield placed in a corner of a classroom against existing classroom walls;
the ballistic shield of the teacher shelter is formed from ballistic steel;
a student communication device and a teacher communication device;
the student communication device including a video screen with camera, microphone, and speaker, connected wirelessly to the teacher communication device;
the student communication device and teacher communication device are connected via a secure wireless network isolated from a school's main data network;
whereby students and a teacher can shelter in place within a classroom during an active shooter event.
